(19) United States
(12) Patent Application Publication
(10) Pub. No.: US 2008/0062483 A1
(43) Pub. Date: Mar. 13, 2008

(54) IMAGE PROCESSING METHOD, IMAGE PROCESSING APPARATUS, MANUSCRIPT READING APPARATUS, IMAGE FORMING APPARATUS AND RECORDING MEDIUM

(76) Inventor: Satoshi MORIMOTO, Osaka (JP)

Correspondence Address: BIRCH STEWART KOLASCH & BIRCH, PO BOX 747, FALLS CHURCH, VA, 22040-0747, US

(21) Appl. No.: 11/854,389

(22) Filed: Sep. 12, 2007

(30) Foreign Application Priority Data
Sep. 13, 2006 (JP) 2006-248303

(51) Int. Cl. H04N 1/46

(52) U.S. Cl. 358/530

(57) ABSTRACT

An ACS processor judges whether or not a pixel has a chromatic color, in accordance with a pixel value of a manuscript image and also counts the number of the chromatic color pixels. When the counted chromatic color pixel number is smaller than a first chromatic color pixel threshold and greater than a second chromatic color pixel threshold, the ACS processor considers that there is the possibility of the error in the judgment as to whether the manuscript corresponding to the image is a color manuscript or monochrome manuscript. Consequently, the contraction image in which the image is contracted to a predetermined size is displayed, and the judgment instruction executed by a user is received.

### CROSS-REFERENCE OF RELATED APPLICATION

This nonprovisional application claims priority under 35 U.S.C. § 119(a) on Patent Application No. 2006-248303 filed in Japan on Sep. 13, 2006, the entire contents of which are hereby incorporated by reference.

### BACKGROUND

1. Technical Field

This application relates to: an image processing method and an image processing apparatus that process an image obtained by reading a manuscript and judging whether the manuscript is a color manuscript or a monochrome manuscript; a manuscript reading apparatus and an image forming apparatus that contain the image processing apparatus; and a recording medium that records a computer program to attain the image processing apparatus.

2. Description of the Related Art

With the advancement of a digital image processing technique in recent years, a digital color copier and a digital color multiple function machine become drastically popular in the offices in corporations and the like. In association with this popularization, the document treated by a user is shifted from a monochrome manuscript to a color manuscript, and the colorization of the document is earnestly tried and used.

Under such situation, the image forming apparatus, such as the digital color copier, the digital color multiple function machine or the like, contains an ACS (automatic color selection) function for automatically judging whether the manuscript is the color manuscript or the monochrome manuscript, in order to perform a suitable image process on the manuscript, when the manuscript in which color and monochrome components are mixed are scanned or copied. Also, the image forming apparatus contains an image editing function in order to obtain the output image desired by a user.

For example, an image processing apparatus, which judges whether the manuscript is a character manuscript or an image manuscript in accordance with the image read from the manuscript, and in the case of the character manuscript, compares the saturation of the image obtained from the manuscript with a first threshold and consequently judges whether it is the color manuscript or the monochrome manuscript, and when the manuscript is the image manuscript, compares the saturation of the image obtained from the manuscript with a second threshold and consequently judges whether it is the color manuscript or the monochrome manuscript and accordingly judges the image of a low saturation as the color and then recognizes the color character of the low saturation as the black character whose visibility is excellent and can properly execute the color/monochrome judgment of the manuscript correspondingly to a manuscript type is proposed (refer to Japanese Laid Open Patent Application No. 2002-44464).

Also, an image processing apparatus, which contains a previewing function for displaying an edition image in order to check whether or not the edition is attained in accordance with the user's desire before the edition image after the execution of the image edition is printed, and forms the image in accordance with the manuscript image data stored in an image memory without reading the manuscript image when a print output is executed, and consequently reduces the process time when the image after the edition is printed and outputted, is proposed (refer to Japanese Laid Open Patent Application No. 09-37065).

However, the image processing apparatus in Japanese Laid Open Patent Application NO. 2002-44464 merely changes the saturation threshold used for the color/monochrome judgment of the manuscript, depending on whether the manuscript is the character manuscript or the image manuscript, and does not consider the color/monochrome judgment of the manuscript, in the case that the manuscript in which the color and monochrome components are mixed includes the particular colors, for example, such as red, green, blue and the like. Thus, for example, in the case of the manuscript in which the particular color is mixed in the monochrome character manuscript, especially in the case of the manuscript in which color pixels are few, even when the printing as the color manuscript is desired, it is not judged to be the color manuscript, and it is erroneously judged to be the monochrome manuscript, and this has the problem that the color manuscript is printed (outputted) as the monochrome manuscript.

Also, the image processing apparatus in Japanese Laid Open Patent Application No. 9-37065, although having the previewing function for checking the edition image, cannot judge whether the manuscript is the color manuscript or the monochrome manuscript. Thus, the image processing apparatus, which can check whether the manuscript is printed as the color manuscript or the monochrome manuscript before the manuscript is printed, is desired.

### SUMMARY

This application is proposed in view of such circumstances. It is therefore an object of the present invention to provide: an image processing method and an image processing apparatus, which judge whether a pixel has a chromatic color or achromatic color in accordance with a pixel value, and when judging as the pixel of the chromatic color (the chromatic color pixel), count the number of chromatic color pixels within the image, and compare the counted number of chromatic color pixels with a first threshold and a second threshold smaller than the first threshold, and when the number of chromatic color pixels is smaller than the first threshold and greater than the second threshold, display the image and accept a specification as to whether the manuscript is the color manuscript or the monochrome manuscript, and as for the manuscript in which the color component is mixed in a black character manuscript, can display and check the image of the manuscript in which the judgment as to whether the manuscript is the color manuscript or the monochrome manuscript is difficult, and can further accept the judgment instruction on the color manuscript or monochrome manuscript executed by the user and prevent of the erroneous output (for example, print) of the color or monochrome manuscript; a manuscript reading apparatus and an image forming apparatus which contain the image processing apparatus; and a computer program for attaining the image processing apparatus.

Also, another object of this application is to provide: an image processing method and an image processing apparatus, which judge whether or not the pixel is the pixel of the particular color when judging the pixel to have the chromatic color, count the number of pixels of a particular color (the number of particular color pixels) when judging as the pixel of the particular color, judge whether or not the counted number of particular color pixels is greater than a predetermined particular color pixel threshold when the number of chromatic color pixels within the image is smaller than the second threshold, display the image when the number of particular color pixels is greater than the particular color pixel threshold, and consequently display the image of the manuscript in which the particular color component is mixed in the black character manuscript and can further simplify the check as to whether the manuscript is outputted as the color manuscript or outputted as the monochrome manuscript; and a manuscript reading apparatus and an image forming apparatus which contain the image processing apparatus.

Also, another object of the present invention is to provide: an image processing method and an image processing apparatus, which count the number of chromatic color pixels for each of a plurality of partial images constituting the image and display the partial image having the greatest counted value and consequently display the part having many chromatic color pixels and can further simplify the judgment as to whether the manuscript is outputted as the color manuscript or outputted as the monochrome manuscript; and a manuscript reading apparatus and an image forming apparatus which contain the image processing apparatus.

Also, another object of this application is to provide: an image processing method and an image processing apparatus, which count the number of particular color pixels for each of the plurality of partial images constituting the image and display the partial image having the greatest counted value and consequently display the part having many particular color pixels and can further simplify the judgment as to whether the manuscript is outputted as the color manuscript or outputted as the monochrome manuscript; and a manuscript reading apparatus and an image forming apparatus which contain the image processing apparatus.

Also, another object of this application is to provide: an image processing method and an image processing apparatus, which judge a manuscript type including at least a character manuscript, in accordance with the pixel value of each pixel of the image, and assign a different weight when counting the number of chromatic color pixels, in accordance with the judged manuscript type, and for example, when the manuscript type is the character manuscript, make the weight greater and can make the judgment of the color manuscript easier; and a manuscript reading apparatus and an image forming apparatus which contain the image processing apparatus.

Also, another object of this application is to provide: an image processing method and an image processing apparatus, which store the number of the manuscripts that are specified to be the color manuscript or the monochrome manuscript by the user, in accordance with the displayed image, and update the first or second threshold in accordance with the stored number of manuscripts, and consequently reflect the judgment result of the user for the manuscript in which the judgment as to whether the manuscript is the color manuscript or the monochrome manuscript is difficult, and can further improve the judgment precision as to whether the manuscript is outputted as the color manuscript or outputted as the monochrome manuscript; and a manuscript reading apparatus and an image forming apparatus which contain the image processing apparatus.

Also, another object of this application is to provide: an image processing method and an image processing apparatus, which store the number of the manuscripts that are specified to be the color manuscript or the monochrome manuscript by the user, in accordance with the displayed image, and the number of chromatic color pixels included in the image corresponding to the manuscripts, and update the first or second threshold in accordance with the stored manuscript number and chromatic color pixel number, and consequently reflect the judgment result of the user for the manuscript in which the judgment as to whether the manuscript is the color manuscript or the monochrome manuscript is difficult, and can further improve the judgment precision as to whether the manuscript is outputted as the color manuscript or outputted as the monochrome manuscript; and a manuscript reading apparatus and an image forming apparatus which contain the image processing apparatus.

Also, another object of this application is to provide: an image processing method and an image processing apparatus, which receive an identification information to identify the user and compare the counted the number of chromatic color pixels with the first and second thresholds corresponding to the received identification information and can consequently change the judgment as to whether the manuscript is outputted as the color manuscript or outputted as the monochrome manuscript, in accordance with the manuscript treated by the user; and a manuscript reading apparatus and an image forming apparatus which contain the image processing apparatus.

The image processing method according to this application is the image processing method that judges whether the manuscript is the color manuscript or the monochrome manuscript, in accordance with the pixel value of the plurality of pixels constituting the image obtained by reading the manuscript and that is characterized by: judging whether the pixel has the chromatic color or achromatic color in accordance with the pixel value; counting the number of chromatic color pixels within said image, when it is judged to be the pixel of the chromatic color; comparing the counted number of chromatic color pixels with a first threshold and a second threshold smaller than the first threshold; displaying said image, when the number of chromatic color pixels is smaller than the first threshold and greater than the second threshold; and accepting a specification as to whether the manuscript corresponding to the displayed image is the color manuscript or the monochrome manuscript.

The image processing method according to this application is characterized by: judging whether or not the pixel judged to have the chromatic color is the pixel of a particular color; counting the number of particular color pixels within said image, when it is judged to be the pixel of the particular color; judging whether or not the counted number of particular color pixels is greater than a predetermined particular color pixel threshold, when the number of chromatic color pixels is smaller than the second threshold; and displaying said image, when the number of particular color pixels is greater than the particular color pixel threshold.

The image processing method according to this application is characterized by: counting the number of chromatic color pixels for each of the plurality of partial images constituting the image; and displaying the partial image having the greatest counted value.

The image processing method according to this application is characterized by: counting the number of particular color pixels for each of the plurality of partial images constituting the image and displaying the partial image having the greatest counted value.

The image processing method according to this application is characterized by: judging the manuscript type, which includes at least the character manuscript, in accordance with the pixel value of the respective pixels in the image; and assigning the different weight when counting the number of chromatic color pixels, in accordance with the judged manuscript type.

The image processing method according to this application is characterized by: storing the number of the manuscripts that are specified to be the color manuscripts or the monochrome manuscripts; and updating the first or second threshold in accordance with the stored manuscript number.

The image processing method according to this application is characterized by: storing the number of the manuscripts that are specified to be the color manuscript or the monochrome manuscript, and the number of chromatic color pixels included in the image corresponding to the manuscript; and updating said first or second threshold, in accordance with the stored number of the manuscripts and the stored number of chromatic color pixels.

The image processing method according to this application is characterized by: storing the first and second thresholds corresponding to the identification information to identify the user; receiving the identification information; and comparing the counted number of chromatic color pixels with the first and second thresholds corresponding to the received identification information.

The image processing apparatus according to this application is the image processing apparatus that judges whether the manuscript is the color manuscript or the monochrome manuscript, in accordance with the pixel value of the plurality of pixels constituting the image obtained by reading the manuscript and that is characterized by containing: a judging unit for judging whether each pixel has a chromatic color or achromatic color, in accordance with a pixel value of each pixel constituting an image that is obtained by reading the manuscript; a counter for counting the number of chromatic color pixels within said image, when it is judged to be the pixel of the chromatic color; a comparator for comparing the counted number of chromatic color pixels with a predetermined first threshold and a second threshold smaller than the first threshold; a displaying unit for displaying said image, when the number of chromatic color pixels is smaller than the first threshold and greater than the second threshold; and an accepting unit for accepting a specification as to whether the manuscript corresponding to the displayed image is the color manuscript or the monochrome manuscript.

A manuscript reading apparatus according to this application is characterized by containing: a manuscript reader for reading the manuscript; and the image processing apparatus, wherein the image obtained when the manuscript reader reads the manuscript is processed by the image processing apparatus.

An image forming apparatus according to this application is characterized by containing the image processing apparatus and an image forming unit for forming the output image in accordance with the image processed by the image processing apparatus.

A recording medium according to this application is characterized by recording thereon a computer program, which requires a computer to judge whether or not the manuscript is the color manuscript or the monochrome manuscript, in accordance with the pixel value of the plurality of pixels constituting the input image and which has: a step of requiring the computer to judge whether the pixel has the chromatic color or achromatic color in accordance with the pixel value; a step of requiring the computer to count the number of chromatic color pixels within the images when the pixel has the chromatic color; a step of requiring the computer to compare the counted the number of chromatic color pixels with the first threshold and the second threshold smaller than the first threshold; and a step of requiring the computer to accept a specification as to whether the manuscript is the color manuscript or the monochrome manuscript when the chromatic color pixel number is smaller than the first threshold and greater than the second threshold.

In this application, whether the pixel has the chromatic color or the achromatic color is judged in accordance with the pixel value of the plurality of pixels constituting the image obtained by reading the manuscript. As for the judgment of the chromatic color/achromatic color, for example, the maximal value and minimal value of the respective values of R, G and B of the pixel are determined, and when the difference value between the maximal value and minimal value is greater than the predetermined difference threshold, its pixel can be judged to be the chromatic color pixel, and when the difference value between the maximal value and minimal value is smaller than the predetermined threshold, its pixel can be judged to be the chromatic color pixel. When the pixel is judged to have the chromatic color, the number of chromatic color pixels within the image is counted. The counted number of chromatic color pixels is compared with the first threshold and the second threshold smaller than the first threshold. Then, when the chromatic color pixel number is smaller than the first threshold and greater than the second threshold, the image is displayed.

When the chromatic color pixel number is greater than the first threshold, the manuscript can be judged to be the color manuscript. Also, when the number of chromatic color pixels is smaller than the second threshold, the manuscript can be judged to be the monochrome manuscript. On the other hand, when the number of chromatic color pixels is smaller than the first threshold and greater than the second threshold, the judgment of the chromatic color or monochrome manuscript is difficult, and there is the possibility of the erroneous judgment. Thus, in order to urge the user to judge whether the manuscript is the color manuscript or the monochrome manuscript, the image is displayed. When the user checks the displayed image and instructs the color manuscript or the monochrome manuscript, its specification is accepted. Consequently, as for the manuscript in which the color component is mixed in the black character manuscript, when the judgment of the chromatic color or monochrome manuscript is difficult, the image of the manuscript is displayed, and the user can check it. Hence, the erroneous output (for example, the print) of the color or monochrome style can be prevented.

Also, in this application, when the pixel is judged to have the chromatic color, whether or not the pixel is the pixel of the particular color (for example, R, G, B or the like) is judged. For example, when the ratio between the R value and the G value of the pixel and the ratio between the R value and the B value thereof are greater than the predetermined ratio thresholds, respectively, the particular color of the pixel is judged to be R (Red). Also, similarly, when the ratio between the B value and the R value of the pixel and the ratio between the B value and the G value thereof are greater than the predetermined ratio thresholds, respectively, the particular color of the pixel can be judged to be B (Blue). When the ratio between the G value and the R value of the pixel and the ratio between the G value and the B value thereof are greater than the predetermined ratio threshold, respectively, the particular color of the pixel can be judged to be G (Green).

When the pixel is judged to be the particular color pixel, the particular color pixel number of the image is counted. When the chromatic color pixel number of the image is smaller than the second threshold (namely, when the manuscript is judged to be the monochrome manuscript), whether or not the counted number of particular color pixels is greater than the predetermined particular color pixel threshold is judged. When the number of particular color pixels is greater than the particular color pixel threshold, the image is displayed. Even when the manuscript is judged to be the monochrome manuscript, when the particular color is included, the image is displayed, and the user can check it. Thus, the check as to whether the manuscript is outputted as the color manuscript or outputted as the monochrome manuscript can be made easier.

Also, in this application, the number of chromatic color pixels is counted for each of the plurality of partial images constituting the image, and the partial image having the greatest counted value is displayed. Thus, the part having the many chromatic color pixels in the image is displayed, which further simplifies the judgment as to whether the manuscript is outputted as the chromatic color or outputted as the monochrome manuscript.

Also, in this application, the number of the particular color pixels is counted for each of the plurality of partial images constituting the image, and the partial image having the greatest counted value is displayed. Thus, the part having the many particular color pixels in the image is displayed, which further simplifies the judgment as to whether the manuscript is outputted as the chromatic color or outputted as the monochrome manuscript.

Also, in this application, the manuscript type (for example, the character manuscript, the photo manuscript or the like) is judged in accordance with the pixel value of the respective pixels in the image obtained by reading the manuscript. In the judgment of the manuscript type, for example, the brightness value is calculated from the pixel value of the pixels in the image, and the binary process is executed. When the difference between the maximal value and the minimal value of the brightness value is greater than the predetermined threshold and when the inversion rotation number obtained by scanning the binary-processed binary image is smaller than the predetermined threshold, the manuscript can be judged to be the character manuscript. When the difference between the maximal value and the minimal value of the brightness value is smaller than the predetermined threshold, the manuscript can be judged to be the photo manuscript. In accordance with the judged manuscript type, the different weight is assigned when the chromatic color pixel number is counted. In the case of the judgment as the character manuscript, for example, when the chromatic color pixels having the particular color of red are counted, the weighted “1.5” is added instead of the addition of “1” as the counted value of the chromatic color. Also, in the case of the judgment as the photo manuscript, for example, when the chromatic color pixels having the particular color of red are counted, “1” as the counted value of the chromatic color is added without any weight assignment. Consequently, even the manuscript in which the color symbol, sign, mark and the like are included in a part of the monochrome character manuscript can be easily judged to be the color manuscript.

Also, in this application, when the judgment of the color manuscript or monochrome manuscript is difficult, the image of the manuscript is displayed. Then, when the user checks the displayed image and instructs the color manuscript or the monochrome manuscript, the number of the instructed manuscripts is stored. The first or second threshold is updated, in accordance with the stored manuscript number. For example, as for the stored manuscript numbers, when the number specified to be the monochrome manuscript is greater than the number specified to be the color manuscript, a predetermined value is added to the second threshold, and the second threshold is increased. Thus, the judgment of the monochrome manuscript is made easy. Also, as for the stored manuscript numbers, when the number specified to be the color manuscript is greater than the number specified to be the monochrome manuscript, a predetermined value is subtracted from the first threshold, and the first threshold is decreased. Hence, the judgment of the color manuscript is made easy.

Also, in this application, when the judgment of the color manuscript or monochrome manuscript is difficult, the image of the manuscript is displayed. Then, when the user checks the displayed image and instructs the color manuscript or the monochrome manuscript, the instructed number of manuscripts and the number of chromatic color pixels included in the image corresponding to the manuscript are stored. The first or second threshold is updated, in accordance with the stored the number of manuscripts and the number of chromatic color pixels. For example, the average value (first average value) of the numbers of chromatic color pixels included in the images corresponding to the respective color manuscript and instructed manuscript is calculated. The calculated first average value is smaller than the first threshold. Also, the average value (second average value) of the numbers of chromatic color pixels in the images corresponding to the respective monochrome manuscript and instructed manuscript is calculated. The calculated second average value is greater than the second threshold. When the first average value is greater than the second average value, the first average value is used as the first threshold. Consequently, the first threshold is decreased. Thus, the judgment of the color manuscript is made easy. Also, when the first average value is greater than the second average value, the second average value is used as the second threshold. Consequently, the second threshold is increased. Hence, the judgment of the monochrome manuscript is made easy.

Also, in this application, the identification information to identify the user is received, and the counted number of chromatic color pixels is compared with the first and second thresholds corresponding to the received identification information. Since the first threshold and second threshold which are different for each user are used, the judgment of the color manuscript or monochrome manuscript can be judged in accordance with the manuscript treated by the user.

In this application, whether the pixel has the chromatic color or the achromatic color is judged in accordance with the pixel value. In the case of the judgment as the pixel of the chromatic color, the chromatic color pixel number in the image is counted, and the counted number of chromatic color pixels is compared with the first threshold and the second threshold smaller than the first threshold. Then, when the number of chromatic color pixels is smaller than the first threshold and greater than the second threshold, the image is displayed, and the instruction as to whether the manuscript is the color manuscript or the monochrome manuscript is received. Thus, as for the manuscript in which the color component is mixed in the black character manuscript, the image of the manuscript in which the judgment of the chromatic color or monochrome manuscript is difficult can be displayed and checked. Also, the judgment instruction of the color manuscript or monochrome manuscript executed by the user can be received, thereby protecting the erroneous output (for example, the print) of the color or monochrome style.

Also, in this application, when the pixel is judged to have the chromatic color, whether or not the pixel is the particular color pixel is judged. Then, when the pixel is judged to be the particular color pixel, the number of particular color pixels in the image is counted. When the number of chromatic color pixels within the image is smaller than the second threshold, whether or not the counted number of particular color pixels is greater than the predetermined particular color pixel threshold is judged. Then, when the number of particular color pixels is greater than the particular color pixel threshold, the image is displayed. Thus, the image of the manuscript in which the particular color is mixed in the black character manuscript is displayed, which can further simplify the check as to whether the manuscript is outputted as the color manuscript or outputted as the monochrome manuscript.

Also, in this application, the number of chromatic color pixels is counted for each of the plurality of partial images constituting the image, and the partial image having the greatest counted value is displayed, and the part having the many chromatic color pixels is displayed, which can further simplify the judgment as to whether the manuscript is outputted as the color manuscript or outputted as the monochrome manuscript.

Also, in this application, the number of particular color pixels is counted for each of the plurality of partial images constituting the image, and the partial image having the greatest counted value is displayed, and the part having the many particular color pixels is displayed, which can further simplify the judgment as to whether the manuscript is outputted as the color manuscript or outputted as the monochrome manuscript.

Also, in this application, the manuscript type that includes at least the character manuscript is judged in accordance with the pixel value of the respective pixels in the image. Then, in accordance with the judged manuscript type, the weight is assigned when the number of chromatic color pixels is counted. Thus, for example, when the manuscript type is the character manuscript, the weight assignment is increased, which can make the judgment as the color manuscript easier.

Also, in this application, in accordance with the displayed image, the number of the manuscripts that are specified to be the color manuscript or monochrome manuscript by the user is stored, and the first or second threshold is updated on the basis of the stored number of manuscripts. Thus, the judgment result of the user for the manuscript in which the judgment of the chromatic color or monochrome manuscript is difficult is reflected, which can further improve the judgment precision as to whether the manuscript is outputted as the color manuscript or outputted as the monochrome manuscript.

Also, in this application, in accordance with the displayed image, the number of the manuscripts that are specified to be the color manuscript or monochrome manuscript by the user and the number of chromatic color pixels included in the image corresponding to the manuscript are stored, and the first or second threshold is updated on the basis of the stored number of manuscripts and the stored number of chromatic color pixels. Thus, the judgment result of the user for the manuscript in which the judgment of the chromatic color or monochrome manuscript is difficult is reflected, which can further improve the judgment precision as to whether the manuscript is outputted as the color manuscript or outputted as the monochrome manuscript.

Also, in this application, the identification information to identify the user is received, and the counted number of chromatic color pixels is compared with the first and second thresholds corresponding to the received identification information. Thus, the judgment as to whether the manuscript is outputted as the color manuscript or outputted as the monochrome manuscript can be changed on the basis of the manuscript treated by the user.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of an image forming apparatus that contains an image processing apparatus according to this embodiment;

FIG. 2 is a block diagram showing a configuration of an ACS processor;

FIGS. 3A and 3B are explanation views showing a judgment example between a chromatic color and an achromatic color;

FIG. 4 is an explanation view showing an example of an icon indication on an operation panel;

FIG. 5 is an explanation view showing a configuration of a user table;

FIG. 6 is an explanation view showing a configuration of a judgment history table;

FIG. 7 is a flowchart showing a processing procedure of an image forming apparatus;

FIG. 8 is a flowchart showing a procedure of a color/monochrome judging process;

FIG. 9 is a flowchart showing a procedure of a chromatic color pixel counting process;

FIG. 10 is a flowchart showing a procedure of an icon indicating process;

FIG. 11 is a flowchart showing a procedure of a color/monochrome instructing process;

FIG. 12 is a flowchart showing a procedure of a chromatic color pixel threshold changing process;

FIG. 13 is a flowchart showing a procedure of another example of the chromatic color pixel threshold changing process;

FIG. 14 is a block diagram showing a configuration of a manuscript reading apparatus according to this embodiment; and

FIG. 15 is a block diagram explaining an inner configuration of an image processing apparatus in which a computer program for executing the foregoing process is installed.

### DETAILED DESCRIPTION

The embodiment will be described below in detail with reference to the drawings.

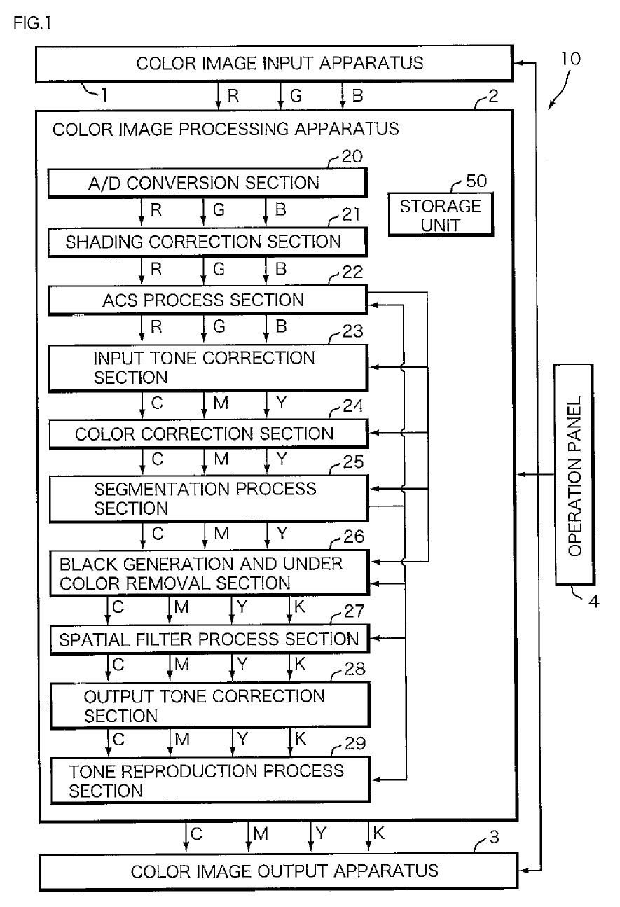

FIG. 1 is a block diagram showing the configuration of an image forming apparatus 10 that contains an image processing apparatus according to this embodiment. The image forming apparatus 10 (for example, a digital color copier and a multiple function machine that has a multiple function, a printer function, and a facsimile and electronic mail distribution function) contains a color image input apparatus 1, a color image processing apparatus 2 (image processing apparatus), a color image output apparatus 3 as an image forming unit, and an operation panel 4 on which a user performs various operations, and the like. The image data of an analog signal of RGB (R: Red, G: Green, and B: Blue), which is obtained when a manuscript is read in the color image input apparatus 1, is outputted to the color image processing apparatus 2, and the color image processing apparatus 2 performs a predetermined process thereon, and this is outputted as a digital color signal of CMYK (C: Cyan, M: Magenta, Y: Yellow, and K: Black) to the color image output apparatus 3.

The color image input apparatus 1 is the scanner that contains, for example, CCD (Charged Coupled Device), and reads a reflection light image from a manuscript image as the analog signal of RGB and outputs the read RGB signal to the color image processing apparatus 2. Also, the color image output apparatus 3 is the image forming unit that uses an electron imaging method or an inkjet method that outputs the image data of the manuscript image onto a record paper. Also, the color image output apparatus 3 may be the displaying apparatus, such as a display or the like. The page numbers based on the input order are given to the manuscript images read by the color image input apparatus 1, and they are correlated to the page numbers and stored once in an image memory (not shown) and held until the completion of the predetermined process in the color image processing apparatus 2.

The color image processing apparatus 2 is provided with CPU, ASIC (Application Specific Integrated Circuit) and the like.

An A/D conversion section 20 converts the RGB signal, which is inputted from the color image input apparatus 1, into a digital signal of, for example, 10 bits and then outputs the RGB signal after the conversion to a shading correction section 21.

The shading correction section 21 performs a correcting process, which removes the various distortions generated in an illuminating system, an image forming system, an image sensing system and the like in the color image input apparatus 1, on the input RGB signal. Also, the shading correction section 21 adjusts a color balance and outputs the RGB signal after the adjustment to an ACS (Automatic Color Section) process section 22.

The ACS process section 22 judges whether the manuscript is the color manuscript or the monochrome manuscript, in accordance with the RGB signal inputted from the shading correction section 21 (namely, the pixel value of each pixel of the image obtained by reading the manuscript, an R value, a G value and a B value). The judgment result is outputted to an input gradation correction section 23, a color correction section 24, a segmentation process section 25 and a black generation and under color removal section 26. Also, the ACS process section 22 outputs the RGB signal inputted from the shading correction section 21 to the input gradation correction section 23. The detail of the ACS process section 22 will be described later.

The input gradation correction section 23 performs a process for adjusting the color balance on the input RGB signal (a reflection factor signal of RGB) and also performs an image quality adjusting process such as a removal of a base concentration or a contrast and outputs the CMY signal after the processing to the color correction section 24.

The color correction section 24 performs a color correction on the input CMY signal, on the basis of the property of the color image output apparatus 3 and outputs the CMY signal after the correction to the segmentation process section 25. Specifically, the color correction section 24 carries out a process for removing the color turbidity in accordance with the spectral characteristic of a CMY color material that includes an unnecessary absorption component, for the sake of the faithfulness of color reproduction.

The segmentation process section 25 separates each pixel in the input image into any of a character region, a network point region, a photo region, in accordance with the input CMY signal. The segmentation process section 25 outputs a region identification signal for indicating the region to which each pixel belongs, to the black generation and under color removal section 26, a spatial filter process section 27 and a tone reproduction process section 29, in accordance with the separation result. Also, the segmentation process section 25 outputs the input CMY signal in its original state to the black generation and under color removal section 26 at the later stage.

Also, the segmentation process section 26 contains a binary processor and the like and judges whether the manuscript is the character manuscript or the photo manuscript. Specifically, the segmentation process section 25 calculates a brightness value in accordance with the input CMY signal and carries out a binary process. The segmentation process section 25 judges the manuscript to be the character manuscript, when the difference between the maximal value and minimal value of the calculated brightness values is greater than a predetermined threshold and when the inversion number obtained by scanning the binary-processed binary image is smaller than a predetermined threshold, and judges the manuscript to be the photo manuscript when the difference between the maximal value and minimal value of the brightness value is smaller than the predetermined threshold. The segmentation process section 25 outputs a judgment signal indicating the manuscript type (the character manuscript or the photo manuscript) to the ACS process section 22.

The black generation and under color removal section 26 generates a K (black) signal in accordance with the CMY signal inputted from the segmentation process section 25 and also subtracts the K signal from the input CMY signal and generates the new CMY signal and then outputs the generated CMYK signal to the spatial filter process section 27.

One example of the process in the black generation and under color removal section 26 will be described below. For example, in a case of a process for executing a black generation through a skeleton black, the input output property of a skeleton curve is assumed to be y=f(x), the input data are assumed to be C, M and Y, the output data are assumed to be C′, M′, Y′ and K′, and a UCR (Under Color Removal) rate is assumed to be α (0<α<1). Then, the data outputted by the black formation base color removing process are represented as K′=f{min(C, M, Y)}, C′=C−αK′, M′=M−αK′, and Y′=Y−αK′, respectively.

The spatial filter process section 27 performs a space filtering process, which uses a digital filter based on a region identification signal, on the CMYK signal inputted from the black generation and under color removal section 26. Thus, the space frequency property of the image data is corrected, which protects the fuzz or granular deterioration in the output image in the color image output apparatus 3. For example, the spatial filter process section 27 emphasizes high frequency components by performing a clarity emphasizing process on the region, which is separated into the character region by the segmentation process section 25, in order to especially improve the reproducibility of the black character or color character. Also, the spatial filter process section 27 performs a low pass filtering process for removing the input network point components, on the region that is separated into the network point region by the segmentation process section 25. The spatial filter process section 27 outputs the CMYK signal after the processing, to an output tone correction section 28.

The output tone correction section 28 performs an output tone correcting process for converting the CMYK signal inputted from the spatial filter process section 27, into a network point area rate that is the property value of the color image output apparatus 3, and outputs the CMYK signal after the output tone correcting process, to a gradation reproduction processor 29.

The gradation reproduction processor 29 performs a predetermined process on the CMYK signal inputted from the output tone correction section 28, in accordance with the region identification signal inputted from the segmentation process section 25. For example, the gradation reproduction processor 29 performs the binary process or multi-level process on the region separated into the character region, so that it is suitable for the reproduction of the high frequency components in the color image output apparatus 3, in order to especially improve the reproducibility of the black character or color character.

Also, the gradation reproduction processor 29 performs a gradation reproducing process (middle tone generation) on the region, which is separated into the network point region by the segmentation process section 25, so that the image is finally separated into the pixels and the respective gradations can be reproduced. Moreover, the gradation reproduction processor 29 performs the binary process or multi-level process on the region, which is separated into the photo region by the segmentation process section 25, so that it is suitable for the gradation reproducibility in the color image output apparatus 3.

The color image processing apparatus 2 once stores the image data (the CMYK signal), which is processed by the gradation reproduction processor 29, in an image memory (not shown), and reads the image data stored in the image memory at a predetermined timing when the image is formed, and then outputs the read image data to the color image output apparatus 3. Those controls are carried out by, for example, CPU (not shown).

The operation panel 4 is provided with a setting button and a displaying unit, for example, such as a liquid crystal display or the like. Then, the operations of the color image input apparatus 1, the color image processing apparatus 2 and the color image output apparatus 3 are controlled in accordance with the information (for example, the user ID to identify the user, the instruction to output the manuscript as the color or monochrome style in accordance with the contraction image displayed on the liquid crystal display, a change instruction between a first chromatic color pixel threshold Th1 and a second chromatic color pixel threshold Th2 which will be described later, and the like) inputted from the operation panel 4. Also, a plurality of images in which the read manuscript image (including the partial image constituting the image) is contracted to a predetermined size are arrayed and displayed on the liquid crystal display contained on the operation panel 4 (for example, an icon indication, a thumbnail indication and the like).

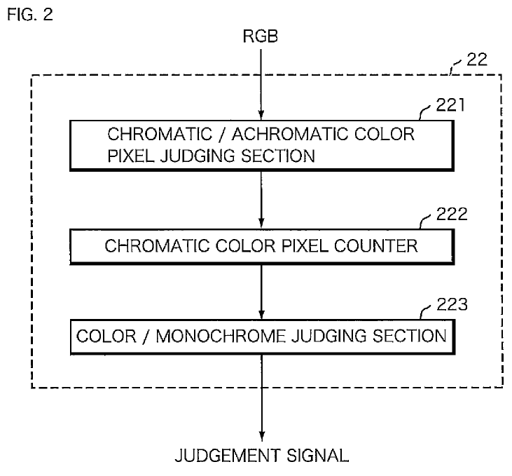

FIG. 2 is a block diagram showing the configuration of the ACS process section 22. The ACS process section 22 contains a chromatic/achromatic color pixel judging section 221, a chromatic color pixel counter 222 and a color/monochrome judging section 223 and the like.

The chromatic/achromatic color pixel judging section 221 judges, for each pixel, whether the pixel is the pixel of the chromatic color or the pixel of the achromatic color, and outputs the judgment result to the chromatic color pixel counter 222. That is, the chromatic/achromatic color pixel judging section 221 determines the maximal value and minimal value of the respective values (for example, between 0 and 255) of R, G and B of the pixels, and judges the pixel as the pixel of the chromatic color when the differential value between the maximal value and the minimal value is greater than a predetermined differential threshold, and judges the pixel as the pixel of the achromatic color when the differential value between the maximal value and the minimal value is smaller than the predetermined differential threshold. The judgment between the chromatic color and the achromatic color is not limited to the foregoing configuration, and the other configurations can be used.

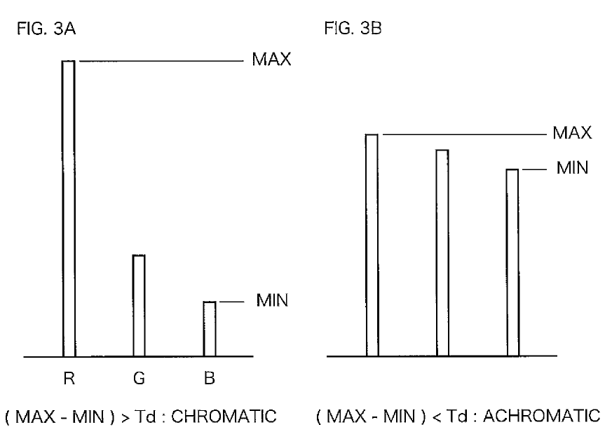

FIGS. 3A and 3B are explanation views showing the judgment examples between the chromatic color and the achromatic color. When the pixel values of the pixel are assumed to be R, G and B, as shown in FIG. 3A, when the difference (Max−Min) between a maximal value Ma and a minimal value Min in R, G and B is greater than a differential threshold Td, the pixel can be judged to be the chromatic color. Also, as shown in FIG. 3B, when the difference (Max−Min) between the maximal value Ma and the minimal value Min in R, G and B is smaller than the differential threshold Td, the pixel can be judged to be the achromatic color.

Also, the chromatic/achromatic color pixel judging section 221 judges, for each pixel, the particular color (for example, red, green, blue or the like) to which the pixel belongs, and outputs the judgment result to the chromatic color pixel counter 222. That is, the chromatic/achromatic color pixel judging section 221 judges the pixel to be the red pixel, for example, when each of a ratio (R/G) between the R value and the G value and a ratio (R/B) between the R value and the B value is greater than a predetermined ratio threshold (for example, 100), in accordance with the respective R, G and B values of the pixel. Also, similarly, this judges the pixel to be the blue pixel, when each of a ratio (B/R) between the B value and the R value and a ratio (B/G) between the B value and the G value is greater than a predetermined ratio threshold (for example, 100), and judges the pixel to be the green pixel, when each of a ratio (G/R) between the G value and the R value and a ratio (G/B) between the G value and the B value is greater than a predetermined threshold (for example, 100). When the foregoing condition is not satisfied, the pixel is judged to be the other chromatic color pixels (the pixels of the chromatic colors except the red, the blue and the green).

Also, when the color/monochrome judging section 223, which will be described later, considers that there is a possibility of an error in a judgment as to whether the manuscript corresponding to the image is the color manuscript or the monochrome manuscript and then outputs the judgment signal to display the image contracted to the predetermined size on the liquid crystal display of the operation panel 4, the chromatic/achromatic color pixel judging section 221 obtains the manuscript image stored in the image memory (not shown), and divides the obtained manuscript image, for example, into 12 partial images of 3×4, and then counts the chromatic color pixel number or the particular color pixel number (for example, the number of the red pixels) for each divided partial image, and further specifies the partial image having the greatest counted value. The chromatic/achromatic color pixel judging section 221 outputs a specification signal in order to display the specified partial image on the liquid crystal display of the operation panel 4.

Furthermore, whether the chromatic color pixel number or particular color pixel number is counted can be properly set. For example, when a chromatic color pixel number NC of the manuscript image is smaller than the second chromatic color pixel threshold Th2, the particular color pixel number can be counted to specify the partial image, and when the chromatic color pixel number NC of the manuscript image is greater than the second chromatic color pixel threshold Th2, the chromatic color pixel number can be counted to specify the partial image.

That is, when the chromatic color pixel number NC is smaller than the second chromatic color pixel threshold Th2, this is the case in which the manuscript is judged to be the monochrome manuscript, and the number of the pixels of the particular color is judged to be greater than the particular color pixel threshold, and the judgment of the color manuscript or the monochrome manuscript is requested for the user. Thus, the part having the greatest number of the particular color pixels is displayed, and the judgment of the chromatic color or monochrome manuscript is requested for the user. Also, when the chromatic color pixel number NC is greater than the second chromatic color pixel threshold Th2, this is the case in which the number of the pixels of the chromatic color is judged to be smaller than the first chromatic color pixel threshold Th1 and greater than the second chromatic color pixel threshold Th2, and the judgment of the color manuscript or monochrome manuscript is requested for the user. Hence, the part having the greatest number of the chromatic color pixels is displayed, and the judgment of the color manuscript or monochrome manuscript is requested for the user.

The chromatic color pixel counter 222 counts the number of the pixels (the chromatic color pixel number) that are judged to be the chromatic color by the chromatic/achromatic color pixel judging section 221. In this case, the chromatic color pixel counter 222 counts the chromatic color pixel number for each pixel obtained by reading the manuscript, namely, for each manuscript, and outputs the counted result (the chromatic color pixel number) to the color/monochrome judging section 223.

Also, the chromatic color pixel counter 222 counts the number of the pixels (the particular color pixel number) that are judged to be the particular color by the chromatic/achromatic color pixel judging section 221, and outputs the counted result to the color/monochrome judging section 223.

Also, the chromatic color pixel counter 222, when counting the chromatic color pixels, assigns a weight to the counted value, on the basis of the particular color to which the chromatic color pixel belongs. That is, the chromatic color pixel counter 222 adds “1” to the counted value each time the pixel is the chromatic color pixel. However, when the chromatic color pixel has the particular color, the weight is assigned to the counted value (for example, “1.5” is set instead of “1”), and the number of the pixels is counted.

Also, the chromatic color pixel counter 222 stores a plurality of weight values, when the weight is assigned. The chromatic color pixel counter 222 selects a predetermined weight value (for example, a weight AR for the red pixel, a weight AG for the green pixel, and a weight AB for the blue pixel, and the like), on the basis of the particular color (for example, the red, the blue, the green and the other chromatic colors) to which the chromatic color pixel belongs.

Also, the chromatic color pixel counter 222 selects and uses the necessary weight value, in accordance with the judgment signal indicating the manuscript type inputted from the segmentation process section 25. For example, when the manuscript type is judged to be the character manuscript, the respective weights AR, AB and AG are become “1.5”, “1.3” and “1.1”. Also, when the manuscript type is judged to be the photo manuscript, all of the respective weights AR, AB and AG become 1. Consequently, even the manuscript in which color symbol, sign and mark and the like are included in a portion of the monochrome character manuscript is avoided from being judged to be the monochrome manuscript, and the colored portion within the manuscript is also suppressed from being outputted as the monochrome style. Thus, this can be easily judged to be the color manuscript.

The color/monochrome judging section 223 compares the chromatic color pixel number inputted from the chromatic color pixel counter 222 with the predetermined first chromatic color pixel threshold Th1 (for example, 9000) and the second chromatic color pixel threshold Th2 (for example, 4000). When the chromatic color pixel number is greater than the first chromatic color pixel threshold Th1, the color/monochrome judging section 223 judges the manuscript corresponding to the image to be the color manuscript and outputs the judgment signal.

Also, when the chromatic color pixel number is smaller than the second chromatic color pixel threshold Th2, the color/monochrome judging section 223 compares the particular color pixel number inputted from the chromatic color pixel counter 222 with a predetermined particular color pixel threshold (for example, 100). When the particular color pixel number is smaller than the predetermined particular color pixel threshold, the manuscript corresponding to the image is judged to be the monochrome manuscript, and its judgment signal is outputted.

In the case that the chromatic color pixel number is smaller than the second chromatic color pixel threshold Th2, when the particular color pixel number is greater than the particular color pixel threshold, the color/monochrome judging section 223 considers that there is the possibility of the error in the judgment as to whether the manuscript corresponding to the image is the color manuscript or the monochrome manuscript, and outputs the judgment signal in order to display the image (for example, the icon) that is contracted to a predetermined size on the liquid crystal display of the operation panel 4.

Also, in the case that the chromatic color pixel number is smaller than the first chromatic color pixel threshold Th1 and greater than the second chromatic color pixel threshold Th2, the color/monochrome judging section 223 considers that there is the possibility of the error in the judgment as to whether the manuscript corresponding to the image is the color manuscript or the monochrome manuscript, and outputs the judgment signal in order to display the image, which is contracted to a predetermined size, on the liquid crystal display of the operation panel 4.

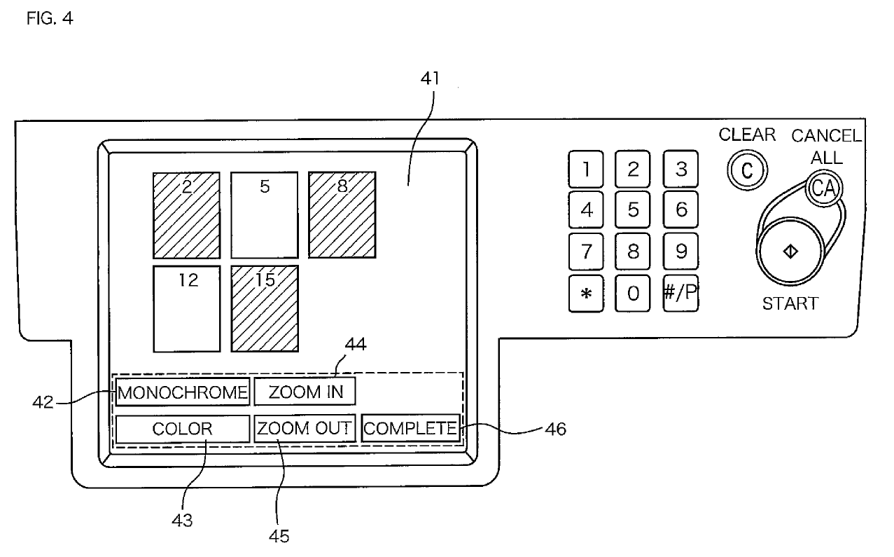

FIG. 4 is an explanation view showing an example of the icon indication on the operation panel 4. As shown in FIG. 4, a liquid crystal display 41, a monochrome button 42 for specifying whether the manuscript is the monochrome manuscript or the color manuscript, a color button 43, a zoom in button 44 to enlarge the icon indication, a zoom out button 45 to contract the icon indication, a completion button 46 to indicate the completion of the operation and the like are placed at the predetermined positions on the operation panel 4. Also, the rectangular frame on the liquid crystal display 41 diagrammatically represents the displayed icon.

For example, when the color/monochrome judging section 223 judges that there is the possibility of the error in the judgment as to whether the manuscripts on the page numbers “2”, “5”, “8”, “12” and “15” are the color manuscripts or the monochrome manuscripts, the five icons on which the images of the manuscripts on the page numbers “2”, “5”, “8”, “12” and “15” are contracted are displayed on the liquid crystal display 41. The user points out the displayed icon and enlarges or contracts the icon indication as necessary, and consequently judges whether the manuscript is the color manuscript or the monochrome manuscript and then operates the color button 43 and the monochrome button 42 for each icon and further specifies the color manuscript or the monochrome manuscript. On the drawing, the manuscripts on the page numbers “2”, “8” and “15” are specified as the monochrome manuscripts, and the manuscripts on the page numbers “5,”, “12” are specified as the color manuscripts.

A storage unit 50 stores a user table provided with: a plurality of user IDs to identify the users; the first chromatic color pixel threshold Th1 and the second chromatic color pixel threshold Th2 that are correlated to each user ID; and a judgment history table ID to identify a judgment history table indicating the judgment specification result of the color manuscript or monochrome manuscript that was previously executed by the user identified by each user ID. Also, the storage unit 50 stores the judgment history table for each user ID.

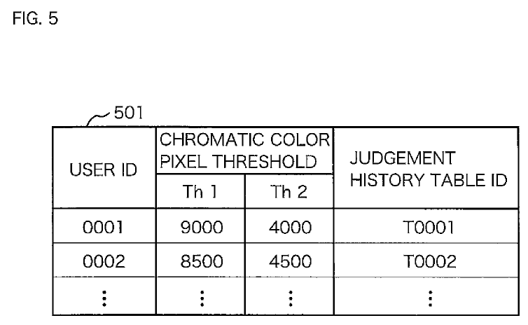

FIG. 5 is an explanation view showing the configuration of a user table 501. As shown in FIG. 5, for example, when the user whose user ID is “0001” uses the apparatus, “0001” as the user ID is inputted from the operation panel 4. Thus, the first chromatic color pixel threshold Th1 (9000) and the second chromatic color pixel threshold Th2 (4000) are selected, and a judgment history in which a judgment history table ID is identified as “T0001” is selected from the judgment history table. Also, similarly, the user whose user ID is “0002” uses the apparatus, a user ID “0002” is inputted from the operation panel 4. Thus, the first chromatic color pixel threshold Th1 (8500) and the second chromatic color pixel threshold Th2 (4500) are selected, and the judgment history in which the judgment history table ID is identified as “T0002” is selected from the judgment history table.

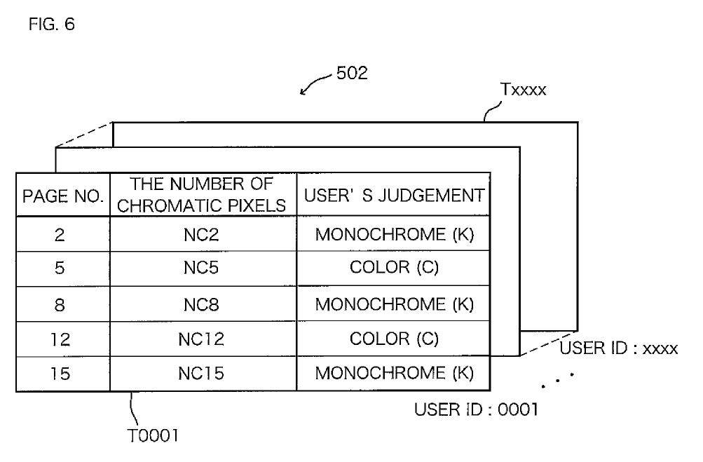

FIG. 6 is an explanation view showing the configuration of a judgment history table 502. The judgment history table 502 stores the judgment history for each user ID identified by the judgment history table ID. The judgment history is provided with: the page number of the manuscript when whether the manuscript is the color manuscript or the monochrome manuscript is specified by the user; the chromatic color pixel number included in the image corresponding to the manuscript; the judgment content of the user; and the like.

For example, as for the judgment history executed by the user whose user ID is “0001”, as indicated in the judgment history table ID of “T0001”, the judgments as to whether the manuscripts having the page numbers of “2”, “5”, “8”, “12” and “15” are the color manuscripts or the monochrome manuscripts are difficult. Thus, the contraction image corresponding to the manuscript is displayed to indicate that the specification of the user is received. Also, the chromatic color pixel numbers included in the images corresponding to the respective manuscripts are NC2, NC5, NC8, NC12 and NC15, respectively. Also, the judgment contents of the users for the respective manuscripts are “Monochrome”, “Color”, “Monochrome”, “Color” and “Monochrome”, respectively. The judgment history table in which ID is “T0001” corresponds to the specification result shown in FIG. 4.

When the operation for the change instruction in the first chromatic color pixel threshold Th1 and the second chromatic color pixel threshold Th2 is carried out on the operation panel 4, the color/monochrome judging section 223 carries out a chromatic color pixel threshold changing process for updating the first chromatic color pixel threshold Th1 and the second chromatic color pixel threshold Th2, correspondingly to each user.

Specifically, the color/monochrome judging section 223 obtains the first chromatic color pixel threshold Th1 and the second chromatic color pixel threshold Th2 and the judgment history table 502, which correspond to the user ID, and counts a number PK of the manuscripts that are judged to be the monochrome manuscripts by the user, and further counts a number PC of the manuscripts that are judged to be the color manuscript by the user.

The color/monochrome judging section 223 compares the counted manuscript numbers PK, CK. Then, when the manuscript number PK is greater than the manuscript number PC, the manuscript in which the judgment as to whether the manuscript is the color manuscript or the monochrome manuscript is difficult has the greater number at which the manuscript is judged to be the monochrome manuscript by the user. Thus, in order that the manuscript is easily judged to be the monochrome manuscript in the future judgment, the second chromatic color pixel threshold Th2 is made high (for example, the value after “1000” is added to the second chromatic color pixel threshold Th2 is defined as the new second chromatic color pixel threshold Th2).

On the other hand, the color/monochrome judging section 223 compares the counted manuscript numbers PK, CK. Then, when the manuscript number PC is greater than the manuscript number PK, the manuscript in which the judgment of the color manuscript or monochrome manuscript is difficult has the greater number at which the manuscript is judged to be the color manuscript by the user. Thus, in order that the manuscript is easily judged to be the color manuscript in the future judgment, the first chromatic color pixel threshold Th1 is made low (for example, the value after “1000” is subtracted from the first chromatic color pixel threshold Th1 is defined as the new first chromatic color pixel threshold Th1). When the manuscript number PK is equal to the manuscript number PC, the first chromatic color pixel threshold Th1 and the second chromatic color pixel threshold Th2 are not updated.

The chromatic color pixel threshold changing process is not limited to the foregoing procedure. This can be attained even by using another method. For example, the color/monochrome judging section 223 obtains the first chromatic color pixel threshold Th1 and the second chromatic color pixel threshold Th2 and the judgment history table 502, which correspond to the user ID, and counts the number PK of the manuscripts that are judged to be the monochrome manuscripts by the user, and also determines the chromatic color pixel number included in the respective manuscripts that are judged to be the monochrome manuscripts by the user. The total value of the determined chromatic color pixel numbers is divided by the manuscript number PK, and an average value Kav of the chromatic color pixel numbers is calculated. For example, with the use of the example of FIG. 6, the average value Kav of the chromatic color pixel numbers can be calculated from Kav=(NC2+NC8+NC15)/3.

Similarly, the color/monochrome judging section 223 counts the number PC of the manuscripts that are judged to be the color manuscripts by the user, and determines the chromatic color pixel numbers included in the respective manuscripts that are judged to be the color manuscripts by the user. The total value of the determined chromatic color pixel numbers is divided by the manuscript number PC, and an average value Cav of the chromatic color pixel numbers is calculated. For example, with the use of the example of FIG. 6, the average value Cav of the chromatic color pixel numbers can be calculated from Cav=(NC5+NC12)/2.

The color/monochrome judging section 223 defines Kav<Cav as the condition and defines the average value Cav as the first chromatic color pixel threshold Th1 and the average value Kav as the second chromatic color pixel threshold Th2. This can reduce the difference between the first chromatic color pixel threshold Th1 and the second chromatic color pixel threshold Th2 and can further improve the judgment precision on the color manuscript or monochrome manuscript. Thus, the necessity of the judgment to be executed by the user can be reduced. In a case of Kav≧Cav, the color/monochrome judging section 223 does not update the first chromatic color pixel threshold Th1 and the second chromatic color pixel threshold Th2.

As for the foregoing two chromatic color pixel threshold changing processes, any one of them may be set as a default, and a predetermined condition may be preliminarily defined to select any one of them correspondingly to the condition. Also, it is possible to employ the configuration in which any one of them is specified by the user. Also, only one of the first chromatic color pixel threshold Th1 and the second chromatic color pixel threshold Th2 may be changed.

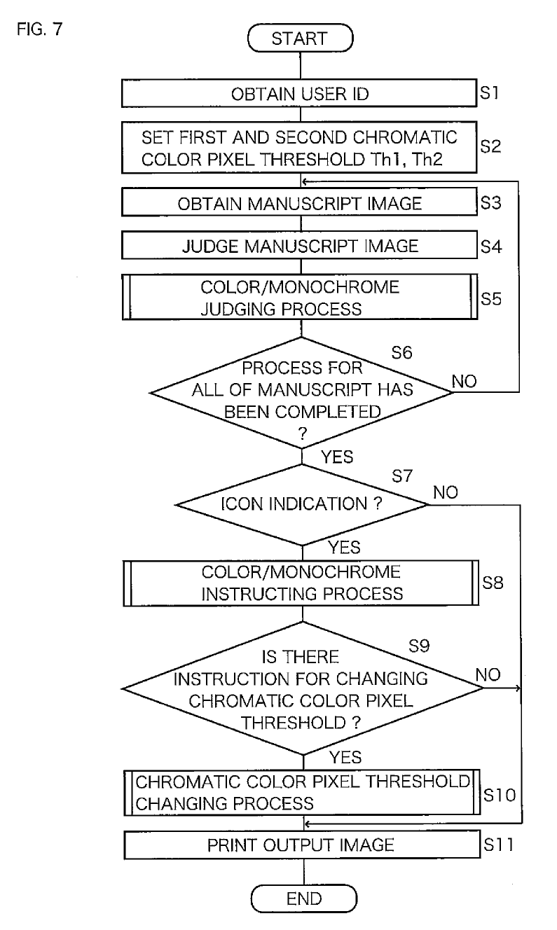

The operations of the image forming apparatus 10 will be described below. FIG. 7 is a flowchart showing the processing procedure of the image forming apparatus 10. The subsequent process can be constituted not only by the dedicated hardware circuit, but also by the configuration in which the computer program for determining the processing procedure is loaded to RAM and executed by CPU (both of them are not shown). In the following explanation, the color image processing apparatus 2 is referred to as “Processor”.

The processor obtains the user ID from the operation panel 4 (S1), and sets the first chromatic color pixel threshold Th1 and the second chromatic color pixel threshold Th2, which correspond to the obtained user ID (S2). The processor obtains the manuscript image (S3) and judges the manuscript type (S4). When the manuscript type is judged, whether the manuscript is the character manuscript or the photo manuscript is judged.

The processor carries out the color/monochrome judging process (S5). The detail of the color/monochrome judging process will be described later. The processor judges whether or not the process for all of the manuscripts has been completed (S6). When the process for all of the manuscripts has not been completed (NO at S6), the processor continues the processes on and after the step S3, and when the process for all of the manuscripts has been completed (YES at S6), the processor judges the presence or absence of the icon indication (S7). Here, the presence or absence of the icon indication indicates whether or not the image after the manuscript image is contracted to the predetermined size (for example, the icon indication image) is displayed on the liquid crystal display of the operation panel 4 by the processor, because there is the possibility of the error in the judgment as to whether the manuscript is the color manuscript or the monochrome manuscript.

When there is the icon indication (YES at S7), the processor carries out a color/monochrome instructing process for requiring the user to carry out the judgment of the color manuscript or monochrome manuscript (S8) and judges whether or not there is an instruction for changing the chromatic color pixel threshold (the first chromatic color pixel threshold Th1 and the second chromatic color pixel threshold Th2) (S9). When there is the instruction for changing the chromatic color pixel threshold (YES at S9), the processor carries out the chromatic color pixel threshold changing process (S10) and prints the output image formed in accordance with the manuscript image (S11) and then finishes the process. The details of the color/monochrome instructing process and the chromatic color pixel threshold changing process will be described later.

When there is not the icon indication (NO at S7), the processor carries out the process of the step S11. Also, when there is not the instruction for changing the chromatic color pixel threshold (NO at S9), the processor carries out the process of the step S11.

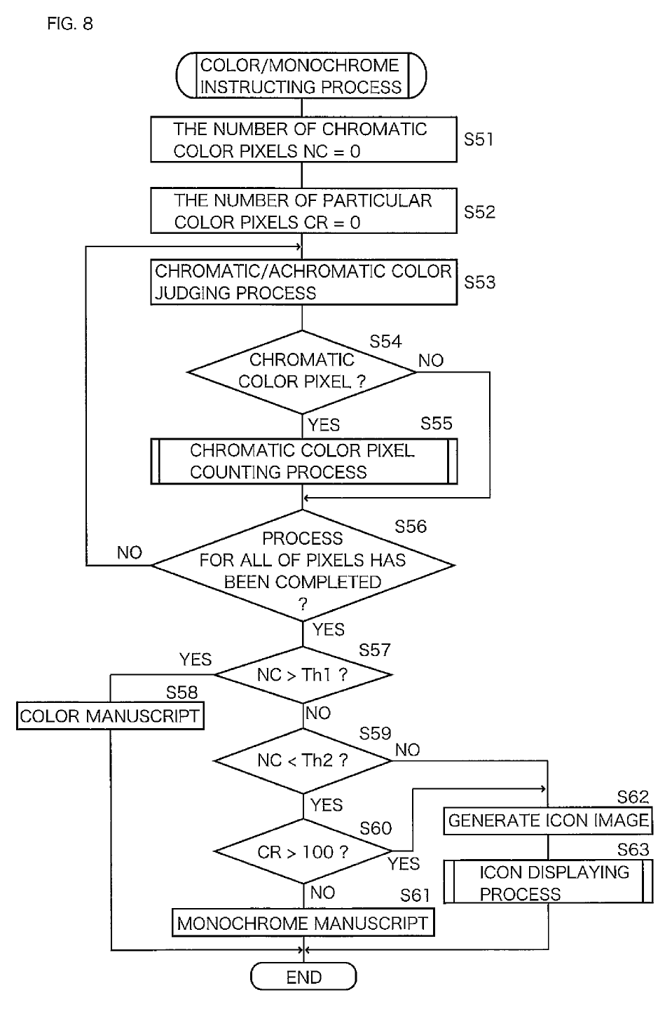

FIG. 8 is a flowchart showing the procedure of the color/monochrome judging process. The processor sets the chromatic color pixel number NC to “0” (S51) and sets the particular color pixel number CR (for example, the number of the red pixels) to “0” (S52). The processor carries out the chromatic/achromatic color judging process for the pixel (S53) and judges whether or not the judged pixel is the pixel of the chromatic color (the chromatic color pixel) (S54).

In the case that it is the chromatic color pixel (YES at S54), the processor carries out the chromatic color pixel counting process (S55) and judges whether or not the process for all of the pixels corresponding to one manuscript has been completed (S56). In the case that it is not the chromatic color pixel (NO at S54), the processor carries out the process of the step S56. The detail of the chromatic color pixel counting process will be described later.

When the process for all of the pixels has been completed (YES at S56), the processor judges whether or not the chromatic color pixel number NC counted by the chromatic color pixel counting process is greater than the first chromatic color pixel threshold Th1 (S57). When the chromatic color pixel number NC is greater than the first chromatic color pixel threshold Th1 (YES at S57), the processor judges that the manuscript is the color manuscript (S58) and finishes the process.

When the chromatic color pixel number NC is not greater than the first chromatic color pixel threshold Th1 (NO at S57), the processor judges whether or not the chromatic color pixel number NC is smaller than the second chromatic color pixel threshold Th2 (S59). When the chromatic color pixel number NC is smaller than the second chromatic color pixel threshold Th2 (YES at S59), the processor judges whether or not the particular color pixel number CR counted by the chromatic color pixel counting process is greater than the particular color pixel threshold (S60).

When the particular color pixel number CR is not greater than the particular color pixel threshold (NO at S60), the processor judges that the manuscript is the monochrome manuscript (S61) and finishes the process. When the chromatic color pixel number NC is not smaller than the second chromatic color pixel threshold Th2 (NO at S59), the processor considers that there is the possibility of the error in the judgment as to whether the manuscript is the color manuscript or the monochrome manuscript, and consequently divides the manuscript image into partial images and generates the partial image specified by the icon displaying process, which will be described later, among the divided partial images as the icon image (S62) and carries out the icon displaying process for displaying the formed icon image (S63) and then finishes the process.

When the particular color pixel number CR is greater than the particular color pixel threshold (YES at S60), the processor considers that there is the possibility of the error in the judgment as to whether the manuscript is the color manuscript or the monochrome manuscript and carries out the processes on and after the step S62. The detail of the icon displaying process will be described later.

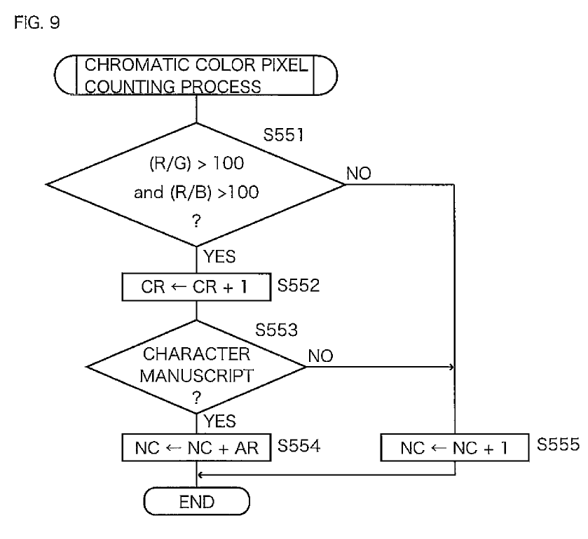

FIG. 9 is a flowchart showing the procedure of the chromatic color pixel counting process. In FIG. 9, the case of the red pixel as the particular color pixel is explained. However, even in the case that the particular color is blue or green, the similar process is executed. The processor judges whether or not the ratio (R/G)>100 and the ratio (R/B)>100 are established, in accordance with the respective values of RGB of the pixel (S551). When the ratio (R/G)>100 and the ratio (R/B)>100 (YES at S551) are established, the processor adds “1” to the red pixel number CR (S552).

The processor judges whether or not the manuscript is the character manuscript, in accordance with the process for the manuscript type judgment (S553). Then, when the manuscript is the character manuscript (YES at S553), this adds the weight AR (for example, “1.5” and the like) to the chromatic color pixel number NC (S554) and then finishes the process.

When the ratio (R/G)>100 and the ratio (R/B)>100 are not established (NO at S551), the processor does not assign the weight and then adds “1” to the chromatic color pixel number NC (S555) and finishes the process. When the manuscript is not the character manuscript (NO at S553), the processor carries out the process of the step S555.

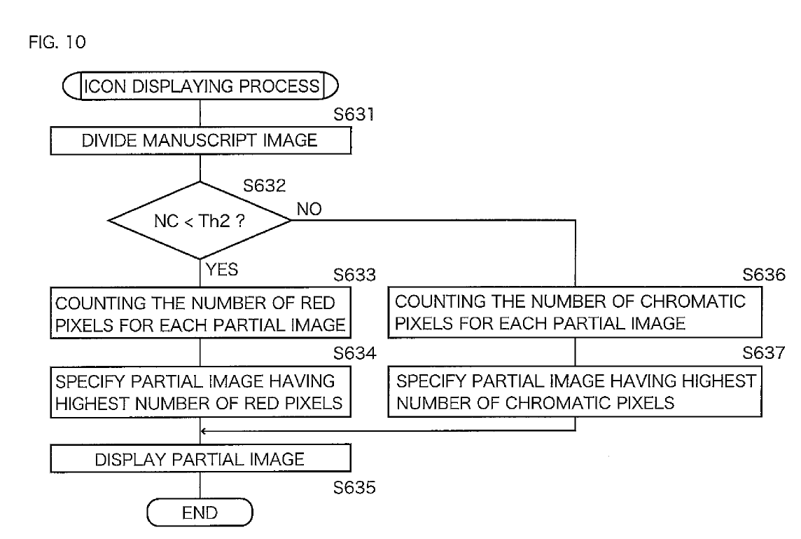

FIG. 10 is a flowchart showing the procedure of the icon displaying process. In FIG. 10, the case of the red pixel as the particular color pixel is explained. However, even in the case that the particular color is blue or green, the similar process is executed. The processor divides the manuscript image into the partial images (S631). In this case, the manuscript image can be divided into, for example, the 12 (3×4) partial images. The processor judges whether or not the chromatic color pixel number NC counted by the chromatic color pixel counting process is smaller than the second chromatic color pixel threshold Th2 (S632).

When the chromatic color pixel number NC is smaller than the second chromatic color pixel threshold Th2 (YES at S632), the processor counts the number of the red pixels for each partial image (S633) and specifies the partial image having the highest counted value (the greatest red pixel number) (S634) and displays the specified partial image (S635) and then finishes the process.

When the chromatic color pixel number NC is not smaller than the second chromatic color pixel threshold Th2 (NO at S632), the processor counts the chromatic color pixel number for each partial image (S636) and specifies the partial image having the highest counted value (the greatest red pixel number) (S637) and carries out the process of the step S635.

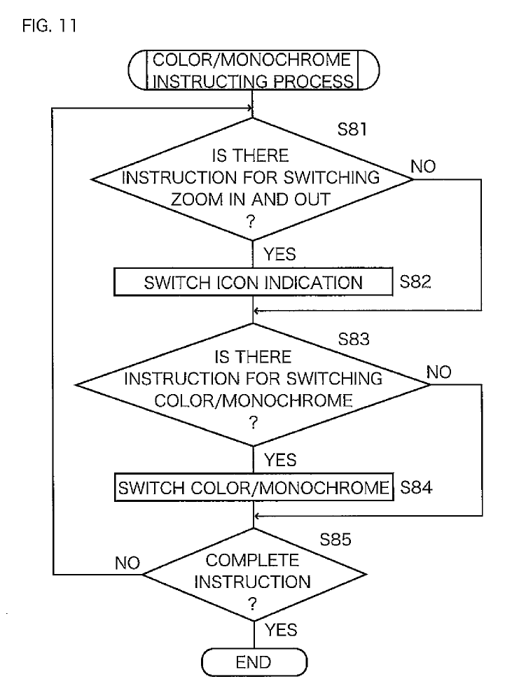

FIG. 11 is a flowchart showing the procedure of the color/monochrome instructing process. The processor judges whether or not there is the instruction of the zoom in and zoom out switching to be executed by the user, for the image displayed as the icon (S81), and when there is the instruction of the enlargement/contraction switching (YES at S81), the icon indication is switched for the sake of the enlargement/contraction (S82).

The processor judges whether or not there is the instruction of the color/monochrome switching to be executed by the user, correspondingly to the fact that the manuscript is judged to be the color manuscript or the fact that the manuscript is judged to be the monochrome manuscript, in accordance with the displayed image (S83). When there is the instruction of the color/monochrome switching (YES at s83), the color/monochrome switching is executed (S84). Consequently, whether the manuscript corresponding to the displayed image is the color manuscript or the monochrome manuscript is judged by the user.

The processor judges whether or not the instruction has been completed, in accordance with the fact as to whether or not the user operates an instruction completion key (S85). When the instruction has not been completed (NO at S85), the processor continues the processes on and after the step S81. When there is not the instruction of the enlargement/contraction switching (NO at s81), the processor carries out the processes on and after the step S83. When there is not the instruction of the color/monochrome switching (NO at S83), the processor carries out the process of the step S85. When the instruction has been completed (YES at S85), the processor finishes the process.

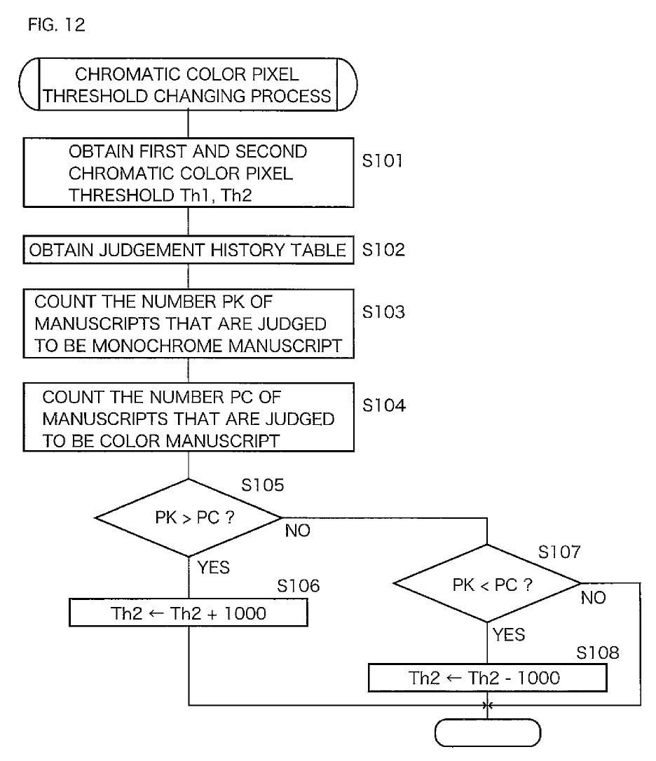

FIG. 12 is a flowchart showing the procedure of the chromatic color pixel threshold changing process. The processor obtains the first chromatic color pixel threshold Th1 and the second chromatic color pixel threshold Th2, which correspond to the user ID (S101), and obtains the judgment history table 502 corresponding to the user ID (S102). The processor refers to the judgment history table 502, and counts the number PK of the manuscripts that are judged to be the monochrome manuscripts by the user (S103) and then counts the number PC of the manuscripts that are judged to be the color manuscripts by the user (S104).

The processor compares the counted manuscript numbers PK, CK and judges whether or not the manuscript number PK is greater than the manuscript number PC (S105). Then, when the manuscript number PK is greater than the manuscript number PC (YES at S105), the manuscript in which the judgment of the color manuscript or monochrome manuscript is difficult has the greater number at which the manuscript is judged to be the monochrome manuscript by the user. Thus, in order that the manuscript is easily judged to be the monochrome manuscript in the future judgment, “1000” is added to the second chromatic color pixel threshold Th2 (S106). Then, the process is finished.

When the manuscript number PK is not greater than the manuscript number PC (NO at S105), the processor judges whether or not the manuscript number PC is greater than the manuscript number PK (S107). When the manuscript number PC is greater than the manuscript number PK (YES at S107), the manuscript in which the judgment of the color manuscript or monochrome manuscript is difficult has the greater number at which the manuscript is judged to be the color manuscript by the user. Thus, in order that the manuscript is easily judged to be the color manuscript in the future judgment, “1000” is subtracted from the first chromatic color pixel threshold Th1 (S108). Then, the process is finished.

When the manuscript number PC is not greater than the manuscript number PK (NO at S107), the processor judges that the manuscript number PK is equal to the manuscript number PC and then finishes the process without changing the first chromatic color pixel threshold Th1 and the second chromatic color pixel threshold Th2.

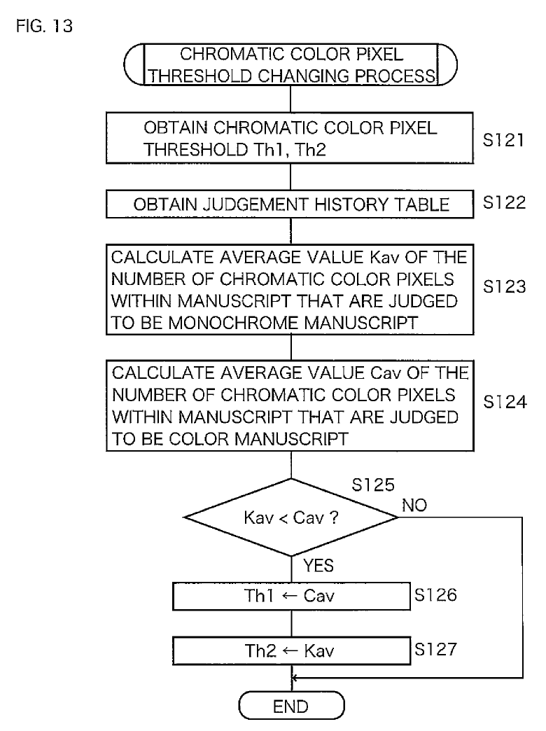

FIG. 13 is a flowchart showing another procedure of the chromatic color pixel threshold changing process. The processor obtains the first chromatic color pixel threshold Th1 and the second chromatic color pixel threshold Th2, which correspond to the user ID (S121), and obtains the judgment history table 502 corresponding to the user ID (S122).

The processor refers to the obtained judgment history table 502 and counts the numbers PK of the manuscripts that are judged to be the monochrome manuscript by the user and also determines the chromatic color pixel numbers included in the respective manuscripts that are judged to be the monochrome manuscripts by the user and further divides the total value of the determined chromatic color pixel numbers and then calculates the average value Kav of the chromatic color pixel numbers (S123).

The processor refers to the obtained judgment history table 502 and counts the numbers PC of the manuscripts that are judged to be the color manuscripts by the user and also determines the chromatic color pixel numbers included in the respective manuscripts that are judged to be the color manuscripts by the user and further divides the total value of the determined chromatic color pixel numbers and then calculates the average value Cav of the chromatic color pixel numbers (S124).

The processor judges whether or not the average value Kav is smaller than the average value Cav (S125). Then, when the average value Kav is smaller than the average value Cav (YES at S125), this defines the average value Cav as the first chromatic color pixel threshold Th1 (S126) and defines the average value Kav as the second chromatic color pixel threshold Th2 (S127) and finishes the process. When the average value Kav is not smaller than the average value Cav (NO at S125), the processor finishes the process without changing the first chromatic color pixel threshold Th1 and the second chromatic color pixel threshold Th2.

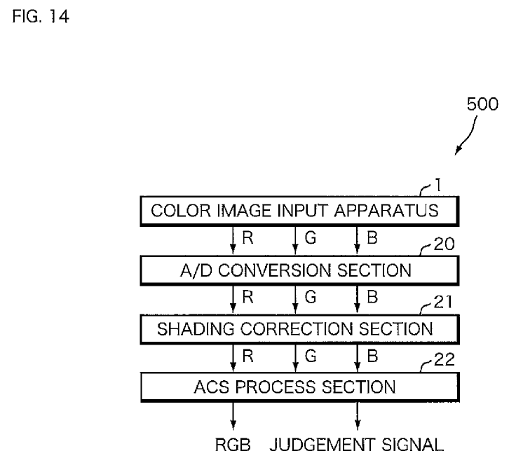

FIG. 14 is a block diagram showing the configuration of a manuscript reading apparatus 500 according to this embodiment. As shown in FIG. 14, the manuscript reading apparatus 500 contains the color image input apparatus 1, the A/D conversion section 20, the shading correction section 21, the ACS process section 22 and the like. The color image input apparatus 1, the A/D conversion section 20, the shading correction section 21 and the ACS process section 22 are similar to the case of the image forming apparatus 10. Thus, their explanations are omitted. Hence, the foregoing processes can be executed in the manuscript reading apparatus.

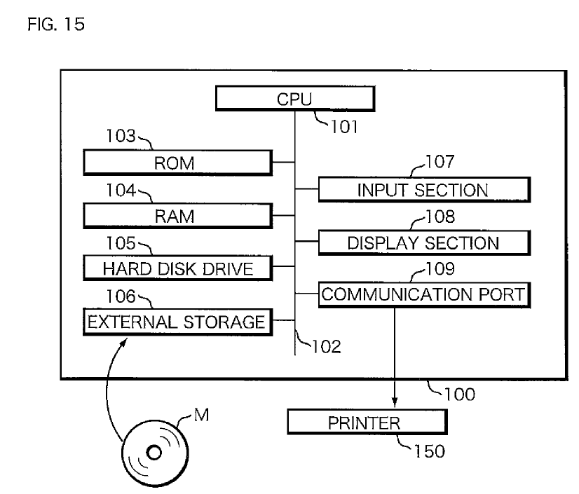

FIG. 15 is a block diagram explaining the inner configuration of the image processing apparatus in which the computer program for executing the foregoing processes is installed. In FIG. 15, 100 indicates the image processing apparatus such as a personal computer, a workstation or the like. The image processing apparatus 100 contains a CPU 101. A ROM 103, a RAM 104, a hard disc 105, an external storage unit 106, an input unit 107, a displaying unit 108, a communication port 109 and the like are connected through a bus 102 to the CPU 101. The CPU 101 controls the respective units of the foregoing hardware, in accordance with the program code of the control program that is stored in advance in the ROM 103.

The RAM 104 is the volatile memory for transiently storing the various data that are generated during the execution of the control program or the computer program for executing the foregoing processes. The hard disc 105 is the storage unit having a magnetically recording medium and stores the program code of the computer program and the like. The external storage unit 106 contains a reader for reading the program code from a recording medium M that records the program code of the computer program for executing the foregoing processes. As the recording medium M, FD (Flexible Disk), CD-ROM and the like can be used. The program code read by the external storage unit 106 is stored in the hard disc 105. The CPU 101 loads the program code stored in the hard disc 105 onto the RAM 104 and executes it. Accordingly, the entire apparatus can function as the apparatus for carrying out the color/monochrome judging process, the chromatic color pixel counting process, the chromatic color pixel threshold changing process and the like.

The input unit 107 functions as an interface to obtain the image data from the outside. For example, a color scanner apparatus and the like are connected to the input unit 107. The displaying unit 108 functions as an interface to display the image data of a processing target, the image data during the processing of the image, the image data after the processing of the image, and the like. This may be configured to connect the external displaying apparatus, such as the liquid crystal displaying device or the like, to the displaying unit 108 and display the image data, or this may be configured such that the displaying unit 108 itself has a displaying device and displays the image data. The communication port 109 is an interface to connect a printer 150 to the outside. When the image data after the processing of the image is printed by the printer 150, the image processing apparatus 100 generates the print data that can be decoded by the printer 150 on the basis of the image data, and the generated print data is transmitted to the printer 150.

The image processing apparatus 100 is configured such that the various calculations are executed by the CPU 101. However, this may be configured such that the dedicated chip for carrying out the calculations related to the image processing is separately installed and the calculations are carried out in accordance with the instruction from the CPU 101.

Also, as the recording medium M for recording the program code of the computer program, in addition to the foregoing FD and CD-ROM, it is possible to use the optical disc such as MO, MD, DVD and the like, the magnetically recording medium such as a hard disc and the like, the card type recording medium such as an IC card, a memory card, an optical card and the like, and the semiconductor memory such as a mask ROM, EPROM (Erasable Programmable, Read Only Memory), EEPROM (Electrically Erasable Programmable Read Only Memory), a flash memory and the like. Also, the system configuration in which the communication network including the Internet can be connected may be designed, and the program code of the computer program for attaining the foregoing processes may be downloaded from the communication network. Also, this can be attained even in the implementation of the computer data signal embedded in a carrier wave in which the program code is embodied in an electronic propagation style.

As mentioned above, in this application, as for the manuscript in which the color symbol, sign, mark and the like are mixed in the manuscript where the black characters are noted, the image of the manuscript in which the judgment of the color manuscript or monochrome manuscript is difficult is displayed, which enables the user to check it and also enables the user to instruct the color manuscript or the monochrome manuscript and further enables the protection of the erroneous output (or print) of the color or monochrome style. Also, as for the image of the manuscript in which the judgment of the color manuscript or monochrome manuscript is difficult, only the partial image having many chromatic color pixels or the partial image having many particular color pixels is displayed. Thus, the judgment on the output as the color manuscript or the output as the monochrome manuscript can be made easier. Also, when the number of the chromatic color pixels is counted, the weight is assigned, depending on the manuscript type. Hence, for example, when the manuscript type is the character manuscript, the weight assignment is made greater, and the judgment of the color manuscript can be made easy.

Also, in accordance with the judgment history of the user, the first chromatic color pixel threshold and the second chromatic color pixel threshold can be updated, and the judgment result of the user for the manuscript in which the judgment of the color manuscript or monochrome manuscript is difficult is reflected, which can further improve the judgment precision as to whether the manuscript is outputted as the color manuscript or outputted as the monochrome manuscript. Also, the identification information to identify the user is received, and the counted chromatic color pixel number is compared with the first chromatic color pixel threshold and the second chromatic color pixel threshold, which correspond to the received identification information. Thus, the judgment as to whether the manuscript is outputted as the color manuscript or outputted as the monochrome manuscript can be changed correspondingly to the manuscript treated by the user.

In the above-mentioned embodiments, the judgment as to whether the manuscript is the color manuscript or the monochrome manuscript is judged by comparing the chromatic color pixel number with the predetermined first chromatic color pixel threshold and second chromatic color pixel threshold. However, the first chromatic color pixel threshold and the second chromatic color pixel threshold can be set to the proper values in advance.

In the above-mentioned embodiments, as the color image input apparatus 1, for example, a flat bed scanner, a film scanner, a digital camera, a portable telephone and the like are used. Also, as the color image output apparatus 3, for example, the image displaying apparatus such as a CRT display, a liquid crystal display and the like, the printer of an electron photographing method or inkjet method that outputs a processing result to a record paper, and the like are used. Moreover, as the image forming apparatus 10, a modem serving as a communication device for the connection through a network to a server apparatus and the like can be contained. Also, instead of the obtainment of the color image data from the color image input apparatus 1, the configuration for obtaining the color image data from an external storage device, a server apparatus and the like through a network may be employed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing method for judging whether a manuscript is a color manuscript or a monochrome manuscript, comprising the steps of:
judging whether each pixel has a chromatic color or achromatic color, in accordance with a pixel value of each pixel constituting an image that is obtained by reading the manuscript;
counting the number of chromatic color pixels within said image, when it is judged to be the pixel of the chromatic color;
comparing the counted number of chromatic color pixels with a first threshold and a second threshold smaller than the first threshold;
displaying said image, when the number of chromatic color pixels is smaller than the first threshold and greater than the second threshold; and
accepting a specification as to whether the manuscript corresponding to the displayed image is the color manuscript or the monochrome manuscript.

2. The image processing method according to claim 1, further comprising the steps of:
judging whether or not the pixel judged to have the chromatic color is the pixel of a particular color;
counting the number of particular color pixels within said image, when it is judged to be the pixel of the particular color;
judging whether or not the counted number of particular color pixels is greater than a predetermined particular color pixel threshold, when the number of chromatic color pixels is smaller than the second threshold; and
displaying said image, when the number of particular color pixels is greater than the particular color pixel threshold.

3. The image processing method according to claim 1, wherein the number of chromatic color pixels is counted for each of a plurality of partial images constituting said image; and the partial image having the greatest counted value is displayed.

4. The image processing method according to claim 2, wherein the number of particular color pixels is counted for each of a plurality of partial images constituting said image; and the partial image having the greatest counted value is displayed.

5. The image processing method according to claim 1, further comprising the steps of:
judging a manuscript type that includes at least a character manuscript, in accordance with a pixel value of each pixel; and
assigning a different weight when the number of chromatic color pixels is counted, in accordance with the judged manuscript type.

6. The image processing method according to claim 1, further comprising the steps of:
storing the number of the manuscripts that are specified to be the color manuscript or the monochrome manuscript; and updating said first or second threshold, in accordance with the stored manuscript number.

7. The image processing method according to claim 1, further comprising the steps of:
storing the number of the manuscripts that are specified to be the color manuscript or the monochrome manuscript, and the number of chromatic color pixels included in the image corresponding to the manuscript; and
updating said first or second threshold, in accordance with the stored number of the manuscripts and the stored number of chromatic color pixels.

8. The image processing method according to claim 1, wherein the first and second thresholds corresponding to an identification information to identify a user are stored;
the identification information is received; and
the counted number of chromatic color pixels is compared with the first and second thresholds corresponding to the received identification information.

9. An image processing apparatus for judging whether a manuscript is a color manuscript or a monochrome manuscript, comprising:
a controller capable of performing operations of;
judging whether each pixel has a chromatic color or achromatic color, in accordance with a pixel value of each pixel constituting an image that is obtained by reading the manuscript;
counting the number of chromatic color pixels within said image, when it is judged to be the pixel of the chromatic color; and
comparing the counted number of chromatic color pixels with a first threshold and a second threshold smaller than the first threshold;
a displaying unit for displaying said image, when the number of chromatic color pixels is smaller than the first threshold and greater than the second threshold; and
an accepting unit for accepting a specification as to whether the manuscript corresponding to the displayed image is the color manuscript or the monochrome manuscript.

10. An image processing apparatus for judging whether a manuscript is a color manuscript or a monochrome manuscript, comprising:
a judging unit for judging whether each pixel has a chromatic color or achromatic color, in accordance with a pixel value of each pixel constituting an image that is obtained by reading the manuscript;
a counter for counting the number of chromatic color pixels within said image, when it is judged to be the pixel of the chromatic color;
a comparator for comparing the counted number of chromatic color pixels with a predetermined first threshold and a second threshold smaller than the first threshold;
a displaying unit for displaying said image, when the number of chromatic color pixels is smaller than the first threshold and greater than the second threshold; and
an accepting unit for accepting a specification as to whether the manuscript corresponding to the displayed image is the color manuscript or the monochrome manuscript.

11. A manuscript reading apparatus comprising:
a manuscript reader for reading a manuscript; and
the image processing apparatus according to claim 9; wherein the image obtained when said manuscript reader reads the manuscript is processed by said image processing apparatus.

12. A manuscript reading apparatus comprising:
a manuscript reader for reading a manuscript; and
the image processing apparatus according to claim 10; wherein the image obtained when said manuscript reader reads the manuscript is processed by said image processing apparatus.

13. An image forming apparatus comprising
the image processing apparatus according to claim 9; and
an image forming unit for forming an output image based on the image processed by the image processing apparatus.

14. An image forming apparatus comprising
the image processing apparatus according to claim 10; and
an image forming unit for forming an output image based on the image processed by the image processing apparatus.

15. A recording medium storing thereon a computer program executable to perform the steps of:
judging whether each pixel has a chromatic color or achromatic color, in accordance with a pixel value of each pixel constituting an image that is obtained by reading the manuscript;
counting the number of chromatic color pixels within said image, when it is judged to be the chromatic color pixel;
comparing the counted number of chromatic color pixels with a predetermined first threshold and a second threshold smaller than the first threshold;
displaying said image, when the number of chromatic color pixels is smaller than the first threshold and greater than the second threshold; and
accepting a specification as to whether the manuscript corresponding to the displayed image is the color manuscript or the monochrome manuscript.
